(19) United States
(12) Patent Application Publication
(10) Pub. No.: US 2022/0412295 A1
(43) Pub. Date: Dec. 29, 2022

(54) ELECTRONICALLY CONTROLLED FUEL INJECTION DEVICE

(71) Applicant: ZAMA JAPAN KABUSHIKI KAISHA, Iwate (JP)

(72) Inventors: Hideki Watanabe, Iwate (JP); Hiroo Ubukata, Iwate (JP)

(21) Appl. No.: 17/847,412

(22) Filed: Jun. 23, 2022

(30) Foreign Application Priority Data
Jun. 25, 2021 (JP) 2021-106123

(51) Int. Cl. F02M 55/00; F02M 51/06

(52) U.S. Cl. CPC F02M 55/007; F02M 55/008; F02M 51/0682; F02M 2200/50

(57) ABSTRACT

An electronically controlled fuel injection device that achieves reduced component count, simplified construction, and cost reduction while promoting discharge of vapor that is generated in a pressurizing chamber. With a fuel passage from a fuel intake pipe into a pressurizing chamber and a return passage that is a discharge passage for vapor generated in the pressurizing chamber, and a plunger with a prescribed reciprocating operation having a standby position set as a position enabling fuel supply and vapor discharge, the electronically controlled fuel injection device eliminates the need for an inlet check valve and promotes the discharge of vapor that is generated when fuel is supplied from the fuel intake pipe to the pressurizing chamber.

### CROSS-REFERENCE TO RELATED APPLICATION

The subject application claims the benefit of Japanese Patent Application No. 2021-106123, filed Jun. 25, 2021, which is incorporated herein by reference in its entirety.

### FIELD

The present invention relates to an electronically controlled fuel injection device that uses a reciprocating plunger to pressure-feed and inject fuel into the air intake port of an engine.

### BACKGROUND

An example of a conventional electronically controlled fuel injection device is proposed in Japanese Unexamined Patent Application 2007-263016 where fuel is pressure-fed using the pump action of an electromagnetically driven plunger and injected through an injection nozzle into the air intake port of an engine. Surplus fuel along with generated or inflowing bubbles (hereinafter called “vapor”) is returned to the fuel tank.

As illustrated in FIG. 4, this conventional electronically controlled fuel injection device causes reciprocating motion of plunger 2 integrated with an armature 1 having a prescribed reciprocating motion through excitation of an electromagnetic coil 3 to supply fuel from a fuel intake pipe 4 connected to a fuel tank (not shown) to a pressurizing chamber 5. The pressurized fuel is injected through an injection nozzle 6, provided downstream of the pressurizing chamber 5, into the air intake port (not shown) of an engine. This conventional electronically controlled fuel injection device does not need a high pressure fuel pump or pressure regulator and, advantageously, can be provided at low cost.

Furthermore, with this type of electronically controlled fuel injection device, reciprocation motion of the plunger 2 driven by the electromagnetic coil 3 causes suction of fuel into the pressurizing chamber and pressure-feeding of the fuel suctioned into the pressurizing chamber. To enable this fuel suctioning and fuel pressure-feeding, an inlet check valve 11 and spill valve 12 must be installed in the passage leading to the pressurizing chamber 5 and this causes an increase in the number of components and an increase in the overall size of the device to secure space for installation.

In addition, vapor generated by suction of fuel into the pressurizing chamber 5 and vapor that naturally flows in accumulates in the pressurizing chamber 5. This vapor is returned to the fuel tank (not shown) via the spill valve 12 provided in the pressurizing chamber 5 along with a portion of the fuel supplied to the pressurizing chamber 5 via a return passage 9 formed between an outer surface 71 of an inner yoke 7 that surrounds the armature 1 and an inner wall surface 81 of a bobbin 8, the outer periphery on which the electromagnetic coil 3 is wound, and through the fuel return pipe 10. However, structurally, the discharge time of the vapor accumulated in the pressurizing chamber 5 is the minute amount of time during the descent stroke of the reciprocating motion of the plunger 2 from a prescribed standby position until the passage on the pressurizing chamber 5 side of the spill valve 12 is blocked off, and thus the vapor discharge effect can not be said to be sufficient.

### SUMMARY

The present example embodiments, which resolve the issues described above, provide an electronically controlled fuel injection device that enables reduced component count, simplified structure, and reduced cost while promoting discharging of vapor generated in the pressurizing chamber.

The electronically controlled fuel injection device, according to an example embodiment, causes reciprocating motion of a plunger positioned at a prescribed standby position by a return spring. The plunger can be reciprocally inserted into a cylindrical pressurizing chamber in conjunction with an armature through excitation of an electromagnetic coil of electric wire wound on the peripheral surface of a bobbin arranged on the outer periphery of the pressurizing chamber. The electronically controlled fuel injection device supplies fuel guided from a fuel tank through a fuel intake pipe via a supply port into the pressurizing chamber and injecting pressurized fuel into an engine from an injection nozzle provided downstream of the pressurizing chamber. A supply port for capturing fuel from the fuel intake pipe and a discharge port for discharging vapor generated in the pressurizing chamber are mutually provided in the pressurizing chamber at a position that is open when the reciprocally operating plunger is at the prescribed standby position. When the reciprocally operating plunger is in the prescribed standby position, the fuel intake pipe and the pressurizing chamber are connected via the supply port and the pressurizing chamber and the return passage are connected via the discharge port so fuel can be captured from the fuel intake pipe into the pressurizing chamber and vapor can be discharged from the pressurizing chamber into the return passage, and while the plunger transitions to the descent stroke, vapor discharge is feasible while the supply port and discharge port are open. While the plunger blocks the supply port and the discharge port, fuel can be pressurized and pressure-fed to the injection nozzle downstream from the pressurizing chamber.

In addition, the electronically controlled fuel injection device, according to another example embodiment, causes reciprocating motion of a plunger positioned at a prescribed standby position by a return spring. The plunger can be reciprocally inserted into a cylindrical pressurizing chamber in conjunction with an armature through excitation of an electromagnetic coil of electric wire wound on the peripheral surface of a bobbin arranged on the outer periphery of the pressurizing chamber. The electronically controlled fuel injection device supplies fuel guided from a fuel tank through a fuel intake pipe via a supply port into the pressurizing chamber and injecting pressurized fuel into an engine from an injection nozzle provided downstream of the pressurizing chamber. A supply passage and discharge passage that use both the supply port for supplying fuel from the fuel intake pipe to the pressurizing chamber and a discharge port for discharging the vapor generated in the pressurizing chamber to the return pipe are formed in a prescribed position on the outer periphery of a passage in the axial direction of the reciprocating plunger and opened to the tip end surface thereof so as to connect to the supply port and discharge port when the plunger is at the standby position. Fuel supply and vapor discharge are feasible while the plunger is in the prescribed standby position Fuel pressurization is feasible from the point the plunger enters descent operation and blocks the supply port and the discharge port. Fuel is pressurized from the point that the plunger blocks the supply port and the discharge port and can be pressure-fed to an injection nozzle that is downstream from the pressurizing chamber.

Furthermore, in both example embodiments, of the supply port and the discharge port provided in the pressurizing chamber, at least the discharge port is provided at a descent position at a prescribed distance below the lower surface position of the plunger at a prescribed standby position. From the start of reciprocating operation descent stroke of the plunger until the discharge port or the supply port is blocked by the plunger, fuel accumulated in the pressurizing chamber is pressurized by only a prescribed pressure forcing discharge of vapor from the discharge port or the supply port.

In addition, in both example embodiments, if fuel guided from the fuel tank by gravity is supplied through the fuel intake pipe into the pressurizing chamber installed at a position lower than the fuel tank, a fuel pump and pressure regulator are not required, enabling providing at an even lower cost.

The electronically controlled fuel injection device, according to the present example embodiments, reduces the number of components, simplifies structure, and achieves cost reduction while promoting discharge of vapor that accumulates in the pressurizing chamber due to high temperature.

Other systems, devices, methods, features and advantages of the subject matter described herein will be or will become apparent to one with skill in the art upon examination of the following figures and detailed description. It is intended that all such additional systems, methods, features and advantages be included within this description, be within the scope of the subject matter described herein, and be protected by the accompanying claims. In no way should the features of the example embodiments be construed as limiting the appended claims, absent express recitation of those features in the claims.

### BRIEF DESCRIPTION OF THE DRAWINGS

The accompanying drawings, which are included as part of the present specification, illustrate the presently example embodiments and, together with the general description given above and the detailed description of the example embodiments given below, serve to explain and teach the principles of the present invention.

FIG. 1 is a front vertical cross-sectional view illustrating an example embodiment.

FIG. 2 is a front vertical cross-sectional view illustrating another example embodiment.

FIG. 3 is a state diagram illustrating the relationship between the reciprocating motion of the plunger and the fuel flow rate in the example embodiment illustrated in FIG. 1 and the comparative example.

FIG. 4 is a front vertical cross-sectional view illustrating a conventional example. It should be noted that the figures are not necessarily drawn to scale and that elements of similar structures or functions are generally represented by like reference numerals for illustrative purposes throughout the figures. It also should be noted that the figures are only intended to facilitate the description of the various embodiments described herein. The figures do not necessarily describe every aspect of the teachings disclosed herein and do not limit the scope of the claims.

### DESCRIPTION OF THE EXAMPLE EMBODIMENTS

Before the present subject matter is described in detail, it is to be understood that this disclosure is not limited to the particular embodiments described, as such may, of course, vary. It is also to be understood that the terminology used herein is for the purpose of describing particular embodiments only, and is not intended to be limiting, since the scope of the present disclosure will be limited only by the appended claims.

Representative examples of the embodiments described herein, which examples utilize many of these additional features and teachings both separately and in combination, will now be described in further detail with reference to the attached drawings. This detailed description is merely intended to teach a person of skill in the art further details for practicing preferred aspects of the present teachings and is not intended to limit the scope of the invention. Therefore, combinations of features and steps disclosed in the following detail description may not be necessary to practice the invention in the broadest sense, and are instead taught merely to particularly describe representative examples of the present teachings.

Moreover, the various features of the representative examples and the dependent claims may be combined in ways that are not specifically and explicitly enumerated in order to provide additional useful embodiments of the present teachings. In addition, it is expressly noted that all features disclosed in the description and/or the claims are intended to be disclosed separately and independently from each other for the purpose of original disclosure, as well as for the purpose of restricting the claimed subject matter independent of the compositions of the features in the embodiments and/or the claims. It is also expressly noted that all value ranges or indications of groups of entities disclose every possible intermediate value or intermediate entity for the purpose of original disclosure, as well as for the purpose of restricting the claimed subject matter. An example embodiment of an electronically controlled fuel injection device of the present invention will be described in detail below based on the drawings.

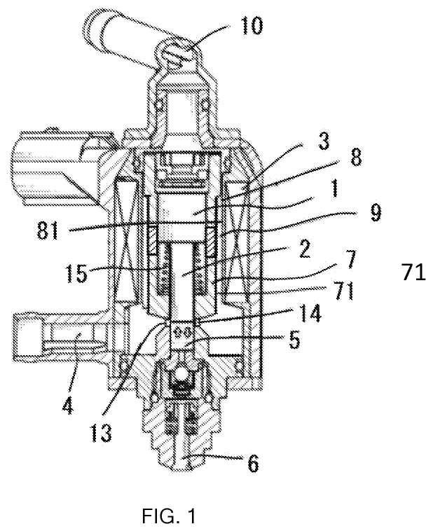

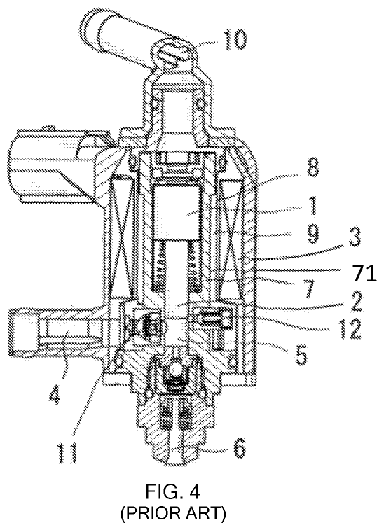

FIG. 1 is a front vertical cross-sectional view illustrating an example embodiment of the first invention. The basic structure and fundamental fuel injection operating conditions, which are the same as the conventionally known device illustrated in FIG. 4, cause a reciprocation operation of a plunger 2 that operates in conjunction with an armature 1 from a standby position with a prescribed reciprocating motion through excitation of an electromagnetic coil 3, and supplies fuel, guided by gravity from a fuel tank (not shown) arranged in a high position, through a fuel intake pipe 4 into a pressurizing chamber 5, such that pressurized fuel is injected from an injection nozzle 6, provided downstream of the pressurizing chamber 5, into the air intake port (not shown) of an engine. In addition, a portion of the fuel supplied to the pressurizing chamber 5 is returned to the fuel tank (not shown) via a return passage 9 formed between an outer surface 71 of an inner yoke 7 surrounding the armature 1 and an inner wall surface 81 of a bobbin 8, the outer periphery on which the electromagnetic coil 3 is wound, and a fuel return pipe 10. The difference between the present example embodiment and the conventional example illustrated in FIG. 4, is that the inlet check valve 11 installed in the conventional example for the purpose of adjusting flow of fuel when fuel is supplied from the fuel intake pipe 4 to the pressurizing chamber 5 and for closing the fuel intake pipe 4 when pressurizing the fuel, and the spill valve 12 installed in the conventional example for adjusting fuel outflow from the pressurizing chamber 5 and discharged into the return passage 9, are not installed in the example embodiment illustrated in FIG. 1.

In addition, in the present example embodiment, a supply port 13 for supplying fuel at a position at the same height as the pressurizing chamber 5 from the fuel intake pipe 4 to the pressurizing chamber 5 and a discharge port 14 for discharging fuel supplied to the pressurizing chamber 5 into the return passage 9 are arranged at the same height.

In particular, with the present example embodiment, when the plunger 2 is in the standby position due to a return spring 15, the tip thereof is positioned at the supply port 13 and discharge port 14. Here, fuel from a fuel tank (not shown) is supplied through the fuel intake pipe 4 and the supply port 13 into the pressurizing chamber 5. At this time, with the present example embodiment, vapor that is inside the pressurizing chamber 5 is discharged from the fuel intake pipe 4 via the supply port 13 and the return passage 9 via the discharge port 14 through the fuel return pipe 10.

In this manner, with the present example embodiment, discharge of vapor that is in the pressurizing chamber 5 is discharged through two vapor discharge paths that include the fuel intake pipe 4 and the fuel return pipe 10. A normally closed type inlet check valve for the plunger standby position is not used as is in a conventional electronically controlled fuel injection device. This ensures a long vapor discharge time and promotes vapor discharge. Furthermore, with the present example embodiment, the plunger 2 that operates in conjunction with the armature 1 moves against the biasing force of the return spring 15 in the tip (injection nozzle 6) direction through excitation of the electromagnetic coil 3 based on a signal from an electronic control device (not shown). The supply port 13 and discharge port 14 are closed by the plunger 2 and fuel in the pressurizing chamber 5 pressurized by the pressurizing chamber 5 is injected from the injection nozzle 6 provided downstream into the air intake port (not shown) of an engine.

Furthermore, when excitation of the electromagnetic coil 3 is stopped by the signal from the electronic control device (not shown), the plunger 2 is driven upwards by the return spring 15 to the standby position opening the supply port 13 and discharge port 14 that had been closed by the plunger 2 and fuel is supplied from the fuel intake pipe 4 to the pressurizing chamber 5.

As has been described, the present example embodiment differs from a conventional example electronically controlled fuel injection device where discharge of vapor in fuel is only performed while the plunger is being driven. Here, vapor is discharged at times when the plunger is not being driven including while the pressurizing chamber 5 is being filled with fuel and thus discharge tends to be sufficient. In addition, unlike the conventional example electronically controlled fuel injection device, the inlet check valve in the fuel intake pipe 4 and spill valve in the return passage 9 that lead to the pressurizing chamber 5 do not need to be provided. Thus, in the present example embodiment, the structure is not complex, component count can be low, and manufacturing cost is inexpensive.

In addition, the present example embodiment has a structure where fuel is guided from a fuel tank (not shown) provided at a high position through the fuel intake pipe 4 and is supplied into the pressurizing chamber 5. Thus, a fuel pump and fuel regulator are not required and there is a benefit that an even lower cost can be achieved. However, it goes without saying that fuel can be supplied from a fuel intake pipe into a pressurizing chamber using a general fuel supply means with a fuel pump and pressure regulator (not shown).

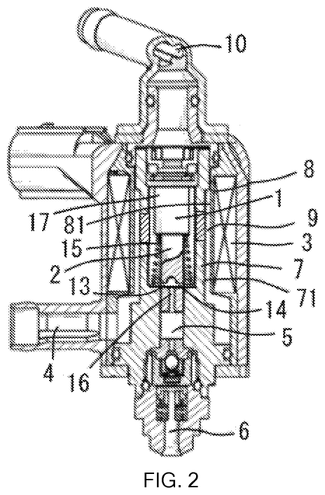

FIG. 2 illustrates another example embodiment according to Invention 2. The overall configuration is similar to the example embodiment illustrated in FIG. 1, but in the example embodiment illustrated in FIG. 1, fuel supplied from the fuel intake pipe 4 is supplied directly from the supply port 13 into the pressurizing chamber 5. Whereas, in the example embodiment illustrated in FIG. 2, fuel supplied from the fuel intake pipe 4 is supplied into a cylinder 17 of the armature 1 and plunger 2 formed on the inner circumference of the inner yoke 7. A passage 16 is formed at the center of the tip of the plunger 2 and opened to the tip surface. The supply port 13 and discharge port 14 are formed to connect to the passage 16 on the outer surface thereof. Fuel supplied to the cylinder 17 is supplied to the supply port 13 with the plunger 2 at the standby position and via the passage 16 to the pressurizing chamber 5, which is opened to the passage 16.

Furthermore, the plunger 2, that operates in conjunction with the armature 1, moves against the biasing force of the return spring 15 in the tip (injection nozzle 6) direction through excitation of the electromagnetic coil 3 based on a signal from an electronic control device (not shown). The supply port 13 and discharge port 14 formed in a cylinder 17 are closed by the plunger 2 and fuel in the pressurizing chamber 5 that is pressurized by the pressurizing chamber 5 is injected from the injection nozzle 6, provided downstream, into the air intake port (not shown) of an engine.

In addition, when excitation of the electromagnetic coil 3 is stopped by the signal from the electronic control device (not shown), the plunger 2 is driven upwards by the return spring 15 to the standby position opening the supply port 13 and discharge port 14 and fuel is supplied from the fuel intake pipe 4 to the pressurizing chamber 5.

Similar to the example embodiment illustrated in FIG. 1, the inlet check valve of the fuel intake pipe 4 and return passage 9 that connect to the pressurizing chamber 5 in the conventional electronically controlled fuel injection device, do not need to be provided, enabling a structure that is not complex, has a low component count, and manufacturing costs that are inexpensive. In addition, the distance of the overall passage is long, so a lot of vapor included in the fuel can be discharged in the standby position.

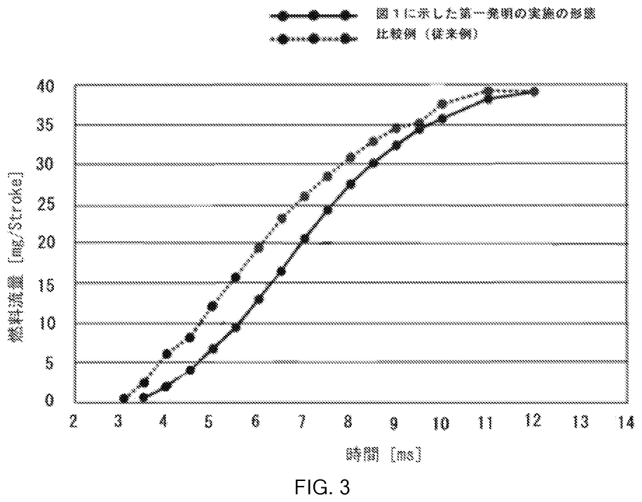

FIG. 3 is a state diagram illustrating the relationship between the reciprocating motion of the plunger and the fuel flow rate in the example embodiment illustrated in FIG. 1 of the present invention and the comparative example that is the conventional example illustrated in FIG. 4 where the example embodiment illustrated in FIG. 1 is mostly the same as that of the comparative example, verifying that there is no hindrance with implementing the present example embodiment.

### DESCRIPTION OF REFERENTIAL NUMERALS

1. Armature
2. Plunger
3. Electromagnetic coil
4. Fuel intake pipe
5. Pressurizing chamber
6. Injection nozzle
7. Inner yoke
8. Bobbin
9. Return passage
10. Fuel return pipe
11. Inlet check valve
12. Spill valve
13. Supply port
14. Discharge port
15. Return spring
16. Passage
17. Cylinder
71. Outer surface
81. Inner wall surface

1. An electronically controlled fuel injection device that causes a plunger, which is positioned at a prescribed standby position by a return spring, to be reciprocally inserted, in conjunction with an armature, into a cylindrical pressurizing chamber through excitation of an electromagnetic coil of electric wire wound on a peripheral surface of a bobbin arranged on an outer periphery of the pressurizing chamber, and wherein fuel being guided from a fuel tank through a fuel intake pipe into the pressurizing chamber, and wherein pressurized fuel from the pressurizing chamber being injected into an engine from an injection nozzle provided downstream of the pressurizing chamber,
wherein the electronically controlled fuel injection device comprising
a supply port for capturing fuel from the fuel intake pipe and a discharge port for discharging vapor generated in the pressurizing chamber, the supply port and the discharge part being provided in the pressurizing chamber at a position where the supply and discharge ports are open when the plunger is at the prescribed standby position,
wherein the fuel intake pipe and the pressurizing chamber are connected via the supply port and the pressurizing chamber and a return passage are connected via the discharge port when the reciprocally operating plunger is in the prescribed standby position to capture fuel from the intake pipe into the pressurizing chamber and discharge vapor from the pressurizing chamber into the return passage, and
wherein vapor is dischargeable while the supply port and discharge port are open as the plunger transitions to the descent stroke, fuel is pressurized and pressure-fed to the injection nozzle downstream from the pressurizing chamber while the plunger blocks the supply port and the discharge port.

2. An electronically controlled fuel injection device that causes a plunger, which is positioned at a prescribed standby position by a return spring, to be reciprocally inserted, in conjunction with an armature, into a cylindrical pressurizing chamber through excitation of an electromagnetic coil of electric wire wound on a peripheral surface of a bobbin arranged on an outer periphery of the pressurizing chamber, and wherein fuel being guided from a fuel tank through a fuel intake pipe into the pressurizing chamber, and wherein pressurized fuel from the pressurizing chamber being injected into an engine from an injection nozzle provided downstream of the pressurizing chamber,
wherein the electronically controlled fuel injection device comprising
a supply passage and a supply port for supplying fuel from the fuel intake pipe to the pressurizing chamber, and a discharge passage and a discharge port for discharging the vapor generated in the pressurizing chamber to a return pipe, the supply port and the discharge port being formed in a prescribed position on an outer periphery of a passage in the axial direction of the reciprocating plunger and opened to a tip end surface of the plunger to connect to the supply port and discharge port when the plunger is at the standby position,
wherein fuel supply and vapor being dischargable while the plunger is in the prescribed standby position, and
wherein fuel being pressurized from the point the plunger enters a descent operation and blocks the supply port and the discharge port, and pressure-fed to an injection nozzle that is downstream from the pressurizing chamber.

3. The electronically controlled fuel injection device according to claim 1, wherein at least the discharge port is provided at a descent position that is a prescribed distance below the lower surface position of the plunger when the plunger is at the prescribed standby position, and wherein from the start of a descent stroke of the plunger until the discharge port or the supply port is blocked by the plunger, fuel that is accumulated in the pressurizing chamber is pressurized by a prescribed pressure forcing discharge of vapor from the discharge port or the supply port.

4. The electronically controlled fuel injection device according to claim 2, wherein at least the discharge port is provided at a descent position that is a prescribed distance below the lower surface position of the plunger when the plunger is at the prescribed standby position, and wherein from the start of a descent stroke of the plunger until the discharge port or the supply port is blocked by the plunger, fuel that is accumulated in the pressurizing chamber is pressurized by a prescribed pressure forcing discharge of vapor from the discharge port or the supply port.

5. The electronically controlled fuel injection device according to claim 1, wherein fuel is guided from the fuel tank by gravity and is supplied through the fuel intake pipe into the pressurizing chamber installed at a position lower than the fuel tank.

6. The electronically controlled fuel injection device according to claim 2, wherein fuel is guided from the fuel tank by gravity and is supplied through the fuel intake pipe into the pressurizing chamber installed at a position lower than the fuel tank.

7. The electronically controlled fuel injection device according to claim 3, wherein fuel is guided from the fuel tank by gravity and is supplied through the fuel intake pipe into the pressurizing chamber installed at a position lower than the fuel tank.
